(19) United States
(12) Patent Application Publication
(10) Pub. No.: US 2015/0357103 A1
(43) Pub. Date: Dec. 10, 2015

(54) COIL HAVING MULTI-LAYER STRUCTURE

(71) Applicant: KOREA RESEARCH INSTITUTE OF STANDARDS AND SCIENCE, Yuseong-gu Daejeon (KR)

(72) Inventors: Young Joo KIM, Daejeon (KR); Dong Jin YOON, Daejeon (KR)

(21) Appl. No.: 14/758,313

(22) PCT Filed: Dec. 27, 2013
(86) PCT No.: PCT/KR2013/012303

§ 371 Date: Jun. 29, 2015

(30) Foreign Application Priority Data
Dec. 27, 2012 (KR) 10-2012-0155022

(51) Int. Cl. H01F 5/00

(52) U.S. Cl. CPC H01F 5/00

(57) ABSTRACT

A coil according to one embodiment of the present invention relates to a coil having a multi-layer structure, comprising n winding wires (n≧2, n is natural number) which are spaced apart from a central axis and wound around the central axis, wherein a first winding of the n windings is wound to a first height in a direction perpendicular to a reference surface, a second winding is wound to a second height lower than the first height in a direction perpendicular to the reference surface, the first winding has a first radius from the central axis, the second winding has a second radius from the central axis, the second radius being smaller than the first radius, and the second winding wire is disposed in the first winding wire.

### TECHNICAL FIELD

The present invention disclosed herein relates to a coil having a multi-layer structure, and more particularly, to a coil having a multi-layer structure by which magnetic field generating efficiency may be improved.

### BACKGROUND ART

Generally, a coil is a component for realizing inductance (L). A coil is produced by covering a highly conductive wire material with an insulating material and then wiring the resultant wire in a ring shape or a spiral shape. A coil plays a role of converting magnetic energy into electric energy. A coil is applied to most electricity-using devices such as a motor, a generator, a transformer, an electromagnet, and a charger. The kinds of a coil include an air-core coil, a core coil, and a troidal coil.

In recent years, a coil having a multi-layer structure has been researched to improve the magnetic field generating efficiency of the coil.

### DISCLOSURE OF THE INVENTION

### Technical Problem

The present invention provides a coil having a multi-layer structure, which improves the magnetic field generating efficiency of the coil.

An embodiment of the present invention provides a coil having a multi-layer structure, the coil including n winding wires (n≧2, n is a natural number) spaced apart from a central axis and wound around the central axis, wherein a first winding wire of the n winding wires is wound to a first height in a direction perpendicular to a reference surface, wherein a second winding wire is wound to a second height lower than the first height in a direction perpendicular to the reference surface, the first winding wire has a first radius from the central axis, and wherein the second winding wire has a second radius from the central axis, the second radius being smaller than the first radius, and the second winding wire is disposed in the first winding wire.

In an embodiment, the first and second winding wires may have the same thickness.

In an embodiment, directions in which the n winding wires are wound may be identical.

In an embodiment, the n winding wires may be wound in a ring shape or a spiral shape around the central axis.

In an embodiment, intervals between the n winding wires may be regular.

Another embodiment of the present invention provides a coil having a multi-layer structure, the coil including a plurality of winding wires respectively wound in a ring shape or a spiral shape around a central axis and having different radii from the central axis, wherein the plurality of winding wires are sequentially disposed according to the radii in a direction which becomes farther from the central axis, and wherein heights of the plurality of winding wires wound in a direction perpendicular to a reference surface become greater as the winding wires are disposed further from the central axis.

In an embodiment, heights of the winding wires wound in a direction perpendicular to the reference surface may become greater as the winding wires are disposed father from the central axis.

In an embodiment, the winding wires may have the same thickness.

In an embodiment, directions in which the winding wires are wound may be identical.

In an embodiment, the winding wires may be wound in a ring shape or a spiral shape around the central axis.

### Advantageous Effects

According to an embodiment of the present, magnetic field generating efficiency of the coil may be improved.

### BRIEF DESCRIPTION OF THE DRAWINGS

FIGS. 1 and 2 illustrate general coils.

FIGS. 3 and 4 illustrate coils according to an embodiment of the present invention.

FIGS. 5 and 6 are graphs for describing effects of the coils illustrated in FIGS. 3 and 4.

FIG. 7 illustrates a thickness measuring device according to an embodiment of the present invention.

FIG. 8 shows an equivalent circuit of a first coil in FIG. 7.

FIG. 9 is a graph showing a voltage and an electric current of a first coil in FIG. 8.

FIG. 10 is a graph showing the strength of a magnetic field according to the thickness of a measuring target sensed by a hall sensor.

FIGS. 11 and 12 are graphs showing the strength of a magnetic field according to the thickness of a measuring target sensed by a cylindrical coil.

### MODE FOR CARRYING OUT THE INVENTION

Structural or functional descriptions, which are specified with reference to embodiments according to the inventive concept set forth herein are merely provided to describe embodiments of the inventive concept. Embodiments of the inventive concept may, however, be embodied in different forms and should not be constructed as limited to the embodiments set forth herein.

Numerous modifications and aspects can be applied to embodiments of the inventive concept. Thus, exemplary embodiments will be described below in more detail with reference to the accompanying drawings. However, embodiments of the inventive concept are not limited to particular aspects. Rather, all modifications, equivalents, and substitutes involved in the ideas and art of the present invention are included.

It will be understood that when a component is referred to as being “connected” or “in contact” with another component, it can be directly connected or in contact with the other component, or another component may also be provided therebetween. On the other hand, it will be understood that when a component is referred to as being “directly connected” or “directly in contact” with another component, no intervening component is disposed therebetween. Other expressions describing relationships between components, such as “between” and “directly between” or “adjacent to” and “directly adjacent to” should be also understood likewise.

The present invention relates to a coil having a multi-layer structure and, more specifically, to a coil having a multi-layer structure by which magnetic field generating efficiency may be improved. Hereinafter, embodiments of the present invention will be described in details with reference to the accompanying drawing so that those skilled in the art of the present invention could easily carry out the technical ideas of the present invention.

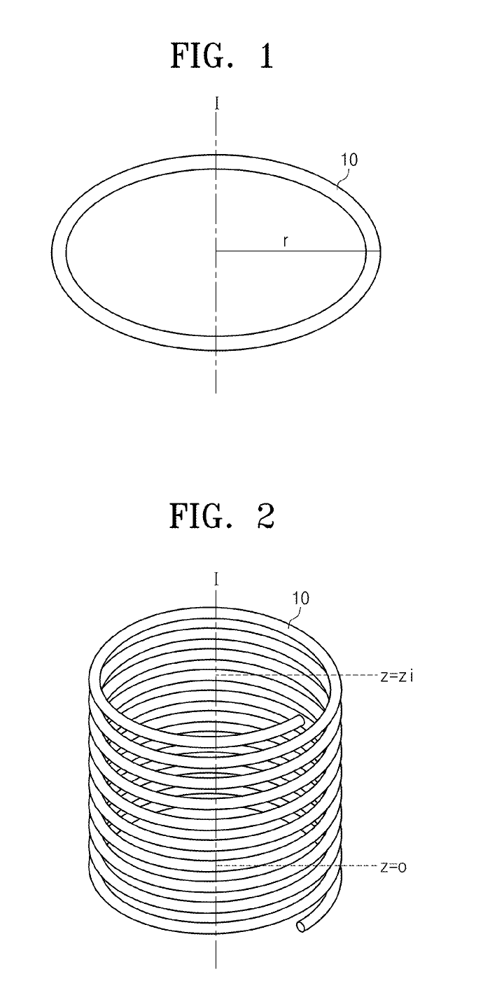

FIGS. 1 and 2 illustrate general coils.

Referring to FIG. 1, a coil 10 made of one winding wire is illustrated. The winding wire of the coil 10 is wound to be spaced a particular distance (a) apart from a central axis (I). The winding wire of the coil 10 is wound in a ring shape around the central axis (I).

Referring to FIG. 2, a coil 10 made of one layer is illustrated. Here, the “layer” may refer to one continuously connected winding wire. That is, the coil 10 is formed by continuously winding, in a Z axis direction, one winding wire that is spaced a radius (a) away from the central axis. Magnetic flux density (B) at the central axis (I) of a reference surface (z=0) may be calculated by using Equation 1 below. For instance, Equation 1 below may be derived by using the Biot-Savart law regarding a magnetic field generated by means of a circular wire.

$$B ( z ) = \frac{{μ}_{0} I}{2} \frac{{a}^{2}}{{( {z}^{2} + {a}^{2} )}^{3 / 2}} \qquad ( Eq . 1 )$$

Here, B represents magnetic flux density, a represents a radius, I represents an electric current, μ₀ represents vacuum permeability, and z represents a distance from the reference surface.

Referring to Equation 1, the magnetic field in the central part of the coil 10 illustrated in FIG. 1 may be expressed as Equation 2 below.

$$B ( 0 ) = \frac{{μ}_{0} I}{2 a} \qquad ( Eq . 2 )$$

As for the coil 10 illustrated in FIG. 2, the magnetic flux density may be calculated by summing up B values from the reference surface (z=0) to z=zi.

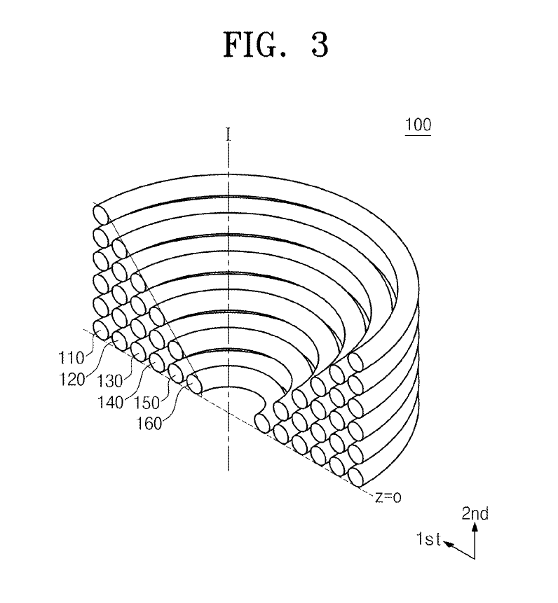

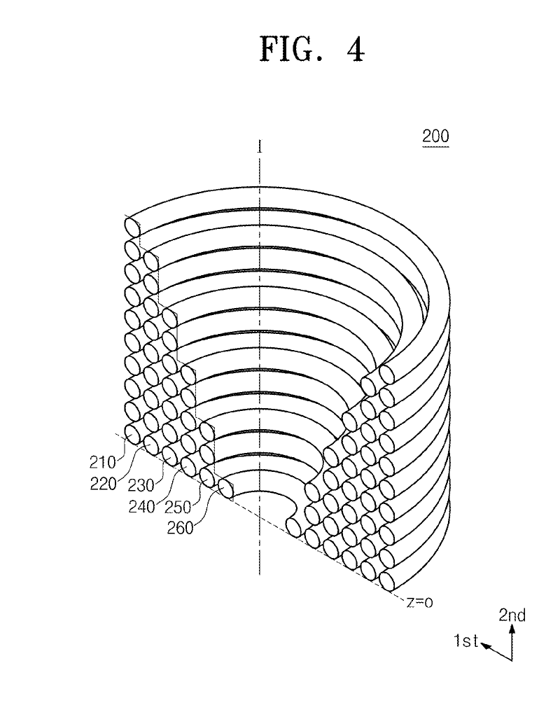

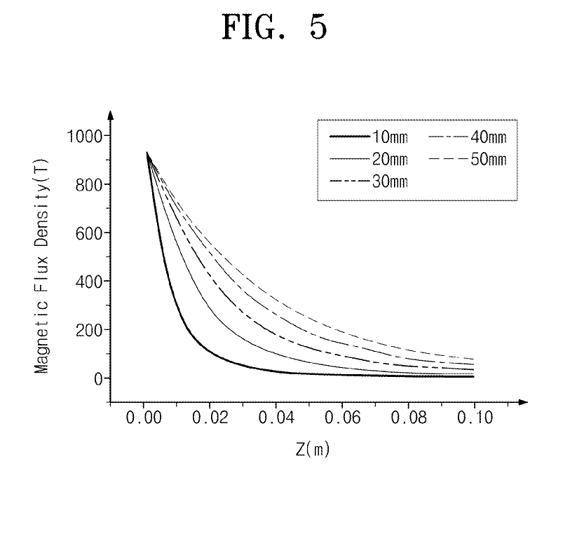

FIGS. 3 and 4 illustrate coils according to an embodiment of the present invention.

Coils in FIGS. 3 and 4 may be understood as coils having a multi-layer structure. That is, the coils illustrated in FIGS. 3 and 4 may have a plurality of winding wires that are sequentially disposed from a central axis (I).

First, referring to FIG. 3, the coil 100 may include a plurality of winding wires 110, 120, 130, 140, 150, and 160 (referred as “110 to 160”). FIG. 3 exemplary illustrates that the number of winding wires is six, but it is not limited thereto. Thus, the number of winding wires may vary depending on a design.

Each of the winding wires 110 to 160 has a radius from the central axis (I). For instance, the winding wire 110 may have the largest radius. The winding wires 110 to 160 may have smaller radius towards a first direction. The first direction may indicate a direction from the winding wire 110 to the winding wire 160. In another aspect, the first direction may indicate a direction that is parallel to the reference surface (z=0). That is, the winding wires 110 to 160 may be sequentially disposed from the central axis (I) according to radii thereof. The winding wires 110 to 160 may be disposed to be spaced particular intervals apart from each other. The intervals between the winding wires 110 to 160 may be regular but are not limited thereto. Accordingly, the winding wires 110 to 160 may form a coil having a multi-layer structure.

The winding wires 110 to 160 may be wound in a ring shape or a spiral shape around the central axis (I). The winding wires 110 to 160 may be wound towards a second direction. The second direction, for instance, may indicate a direction that is parallel to the central axis (I). In another aspect, the second direction may indicate a direction that is perpendicular to the reference surface (z=0). The winding wires 110 to 160 may be wound, for example, in the same direction (for instance, a clockwise direction).

The winding wires 110 to 160 may be designed such that heights of the winding wires wound in the second direction gradually decrease towards the first direction. For instance, heights of the winding wire 120, winding wire 130, winding wire 140, winding wire 150, and winding wire 160, which are wound in the second direction, may respectively lower than those of the winding wire 110, winding wire 120, winding wire 130, winding wire 140, and winding wire 150. That is, the inside of the coil 100 may be understood to have a reversed pyramid shape.

Referring to FIG. 4, the coil 200 may include a plurality of winding wires 210, 220, 230, 240, 250, and 260 (referred as 210 to 260 below). Descriptions that are the same as what described with FIG. 3 will not be provided herein.

The winding wires 210 to 260 may be sequentially disposed on the central axis (I) according to radii thereof. The winding wires 210 to 260 may be designed such that heights of the winding wires wound in the second direction gradually decrease towards the first direction. For instance, heights of the winding wire 220, winding wire 230, winding wire 240, winding wire 250, and winding wire 260, which are wound in the second direction, may be lower than those of the winding wire 210, winding wire 220, winding wire 230, winding wire 240, and winding wire 250.

A difference in a height between the winding wires 210 to 260 that are wound in the second direction may be larger than a difference in a height between the winding wires 110 to 160 that are wound in the second direction. That is, it may be understood that the inside of the coil 200 has a stair shape.

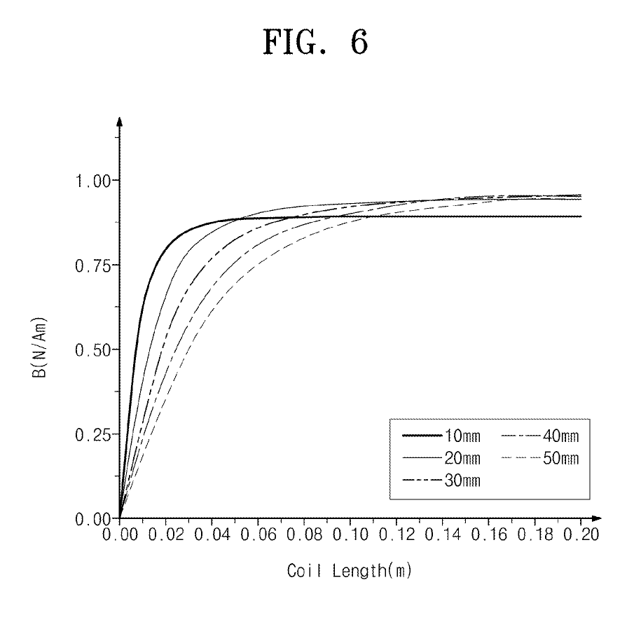

FIGS. 5 and 6 are graphs for describing effects of the coils illustrated in FIGS. 3 and 4.

FIG. 5 shows a change in magnetic flux density at a central axis of a coil made of one winding wire. The magnetic flux density may be calculated while increasing a z value from a reference surface (z=0) (that is, when the coil is positioned far away from the reference surface). The magnetic flux density may be calculated while changing a radius of the winding wire from the central axis (I).

Referring to FIG. 5, as a coil made of a winding wire having a small radius from the central axis (I) has a larger z value than a coil made of a winding wire having a large radius, a decrease in the magnetic flux density becomes greater. In particular, a coil made of a winding wire having a radius of 10 mm from the central axis (I) has a larger z value than a coil made of a winding wire having a radius of approximately 20 to 50 mm from the central axis (I), and thus a decrease in the magnetic flux density becomes greater.

FIG. 6 shows a change in a magnetic field on the reference surface versus a change in the length of a coil in the z axis direction.

Referring to FIG. 6, as the length of a coil increases in the z axis direction, the strength of a magnetic field on the reference surface (z=0) also increases. As described with reference to FIG. 2, this is because magnetic flux density is calculated by summing up B values from the reference surface (z=0) to z=zi. However, when the coil has a predetermined length or more, an increase in the magnetic field is slowed. Here, the predetermined length may be defined as an effective length.

A coil made of a winding wire having a small radius from the central axis (I) has a shorter effective length than a coil made of a winding wire having a large radius from the central axis (I). For instance, an effective length of a coil made of a winding wire having a radius of 10 mm from the central axis (I) is approximately 0.05 m. An effective length of a coil made of a winding wire having a radius of 50 mm from the central axis (I) is approximately 0.16 m.

That is, a coil made of a winding wire having a small radius from the central axis (I) has a smaller influence on an increase in a magnetic field as a length of the coil becomes longer.

The longer the length of the coil is, the larger the resistance and inductance of the coil are. Increases in the resistance and inductance of the coil results in a decrease in an electric current under a particular voltage and rather hinders the generation of a magnetic field. Accordingly, it may be understood that, in the case of a coil having a multi-layer structure, a winding wire having a small radius wound inside thereof may be unhelpful to the generation of a magnetic field compared to a winding wire having a large radius wound outside thereof. Moreover, the winding wire having a small radius wound inside thereof may result in an increase in the resistance and inductance of the coil, which may become a factor of hindering the heat of the coil from being released.

Referring to FIGS. 3 and 4 again, in each of the coils 100 and 200, as a winding wire is closer to the central axis (I), the height of the winding wire wound in the second direction becomes smaller. That is, a winding wire closer to the central axis (I) has a shorter length from the reference surface (z=0).

Accordingly, an influence of a coil made of a winding wire having a small radius from the central axis (I) on a magnetic field generated by a coil having a multi-layer structure may be reduced. That is, the magnetic field generating efficiency of a coil having a multi-layer structure may be improved. This may means that when the same voltage is applied to the coils 100 and 200, the strength of a magnetic field and/or the magnitude of an induced current is/are increased.

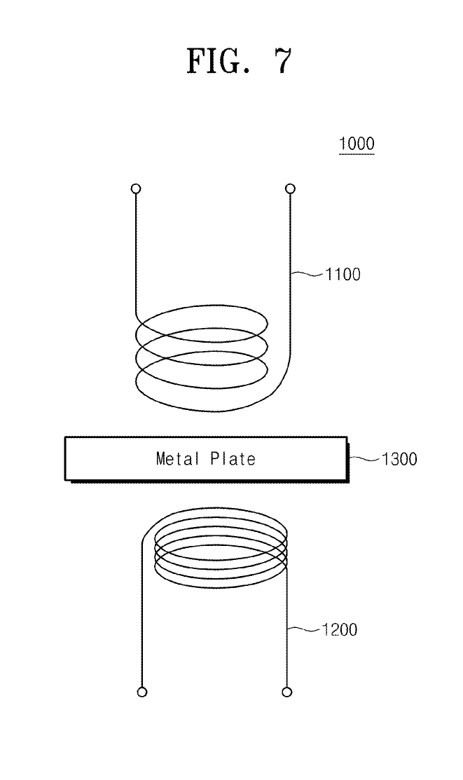

FIG. 7 illustrates a thickness measuring device according to an embodiment of the present invention.

Referring to FIG. 7, a thickness measuring device 1000 according to an embodiment of the present invention may include a first coil 1100, a second coil 1200, and a measuring target 1300.

The first coil 1100 may receive a voltage from the outside and generate a magnetic field. An eddy current may be generated on the measuring target 1300 due to the generated magnetic field. The eddy current may decrease towards the inside of the measuring target 1300. The generated magnetic field may be transferred to the second coil 1200 by passing through the measuring target 1300. The strength of the magnetic field may be varied (ex. reduced) while passing through the measuring target 1300. The first coil 1100 may have the same structure and function as the coils 100 and 200 described in FIGS. 3 and 4.

The second coil 1200 may detect the magnetic field generated from the first coil 1100. The second coil 1200 may detect the magnetic field generated from the first coil 1100 as the strength of an induced voltage or magnetic field. A thickness of the measuring target 1300 may be determined according to the detected strength of an induced voltage or magnetic field. This is because the magnetic field generated from the first coil 1100 may be differently changed (ex. attenuated) depending on a material and/or a thickness of the measuring target 1300 while being transferred to the second coil 1200. The second coil 1200, for instance, may be replaced by a hall sensor or a giant magnetic resistive (GMR) sensor.

The measuring target 1300 may be, for example, a metal plate such as aluminum and steel sheets.

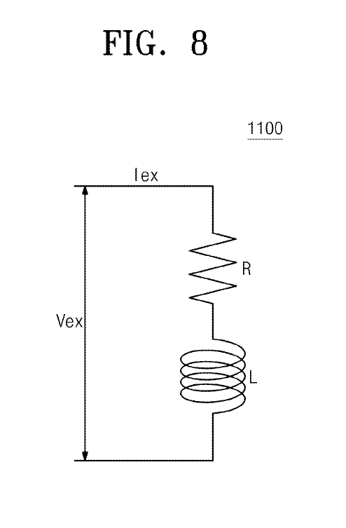

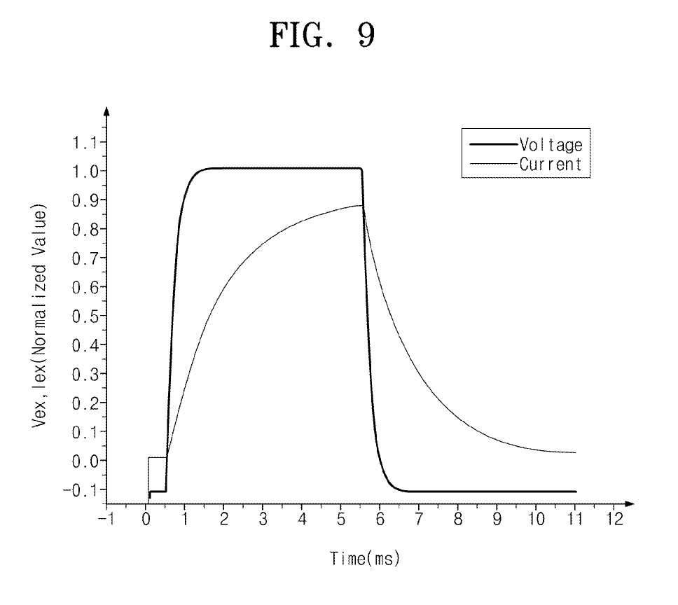

FIG. 8 shows an equivalent circuit of a first coil in FIG. 7. FIG. 9 is a graph showing a voltage and an electric current of a first coil in FIG. 8.

Referring to FIG. 8, the first coil 1100 may be modeled in an equivalent circuit configured with a resistor R and an inductor L. When an external voltage Vex is applied to the first coil 1100, an electric current Iex passing through the first coil 1100 may be calculated through Equations 3 and 4 below.

$$\begin{matrix}Vex = R Iex + L \frac{d i}{d t} & ( Eq . 3 ) \\ Iex = \frac{V}{R} ( 1 - {e}^{- Rt / L} ) & ( Eq . 4 )\end{matrix}$$

Here, Vex is an external voltage applied to the first coil 1100, Iex is an electric current passing through the first coil 1100, R is equivalent resistance, and L is equivalent inductance.

Referring to FIG. 9, an external voltage Vex applied to the first coil 1100 and a generated electric current Iex are illustrated. The external voltage Vex, for instance, may be intensively applied for 0.5 ms to 6 ms with the largest voltage of approximately 1.0 V. The electric current Iex continuously increases for 0.5 ms to 6 ms during which the external voltage Vex is applied, and decreases from 6 ms.

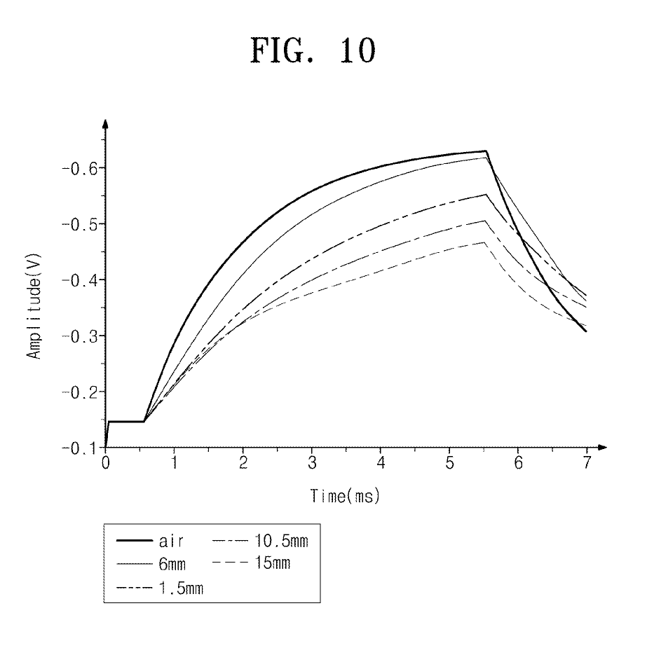

FIG. 10 is a graph showing the strength of a magnetic field according to a thickness of a measuring target sensed by a hall sensor.

Referring to FIG. 10, it is illustrated that a hall sensor is used as the second coil 1200. In particular, in FIG. 10, the strengths of magnetic fields passing through aluminum plates having different thicknesses are measured as an induced voltage. The magnitude of an induced voltage sensed by the hall sensor differs depending on the thickness of the measuring target 1300. The intensity of the induced voltage is measured to be lower in the case where the thickness of the measuring target 1300 is approximately 15 mm than the case where the thickness of the measuring target 1300 is approximately 1.5 mm.

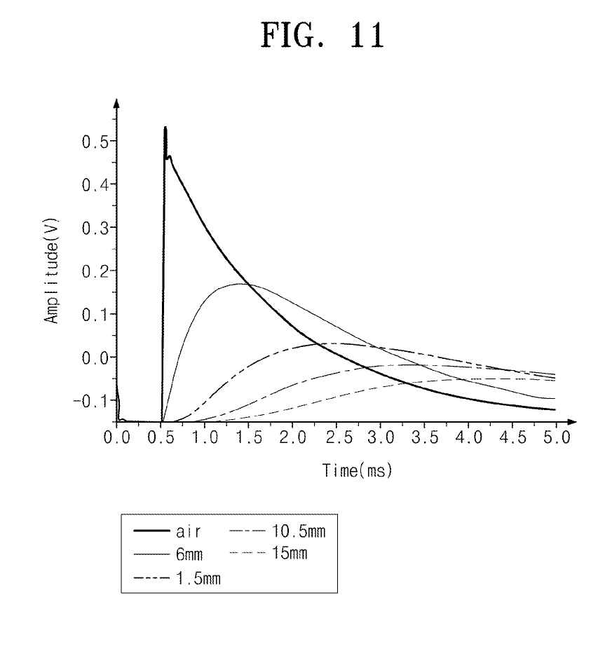

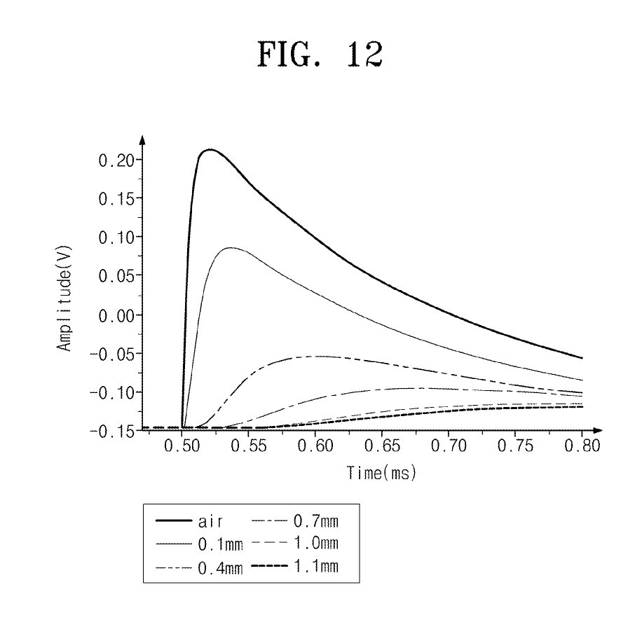

FIGS. 11 and 12 are graphs showing the strength of a magnetic field according to a thickness of a measuring target sensed by a coil.

Referring to FIGS. 11 and 12, it is illustrated that a cylindrical coil is used as the second coil 1200. In particular, in FIG. 11, the strengths of magnetic fields passing through aluminum plates having different thicknesses are measured as an induced voltage. In FIG. 12, the strengths of magnetic fields passing through steel sheets having different thicknesses are measured as an induced voltage. The magnitude of an induced voltage sensed by the cylindrical coil differs depending on the thickness of the measuring target 1300.

Referring to FIGS. 10 to 12, it may be confirmed that the magnitude of an induced voltage sensed by the second coil 1200 varies with the thickness of the measuring target 1300. That is, as the thickness of the measuring target 1300 becomes thicker, a degree of attenuation in a magnetic field becomes greater. Accordingly, the thickness of the measuring target 1300 may be measured by sensing such a change in the magnitude of an induced voltage.

Although illustrative embodiments have been described in the detailed description of the present invention, numerous other modifications can be devised within the scope and technical idea of the present invention. Thus, the scope of the present invention shall not be restricted or limited by the foregoing detailed description, and is to be determined by the broadest permissible interpretation of the following claims and their equivalents.

1. A coil having a multi-layer structure, the coil comprising:
n winding wires (n≧2, n is a natural number) spaced apart from a central axis and wound around the central axis,
wherein a first winding wire of the n winding wires is wound to a first height in a direction perpendicular to a reference surface,
wherein a second winding wire is wound to a second height lower than the first height in a direction perpendicular to the reference surface,
wherein the first winding wire has a first radius from the central axis, and the second winding wire has a second radius from the central axis, the second radius being smaller than the first radius, and
wherein the second winding wire is disposed in the first winding wire.

2. The coil of claim 1, wherein the first and second winding wires have the same thickness.

3. The coil of claim 1, wherein directions in which the n winding wires are wound are identical.

4. The coil of claim 1, wherein the n winding wires are wound in a ring shape or a spiral shape around the central axis.

5. The coil of claim 1, wherein intervals between the n winding wires are regular.

6. A coil having a multi-layer structure, the coil comprising:
a plurality of winding wires respectively wound in a ring shape or a spiral shape around a central axis and having different radii from the central axis,
the plurality of winding wires are sequentially disposed according to the radii in a direction which becomes farther from the central axis, and
wherein heights of the plurality of winding wires wound in a direction perpendicular to a reference surface become greater as the winding wires are disposed further from the central axis.

7. The coil of claim 6, wherein heights of the winding wires wound in a direction perpendicular to the reference surface become greater as the winding wires are disposed father from the central axis.

8. The coil of claim 6, wherein the winding wires have the same thickness.

9. The coil of claim 6, wherein directions in which the winding wires are wound are identical.

10. The coil of claim 6, wherein the winding wires are wound in a ring shape or a spiral shape around the central axis.
